(19) United States
(12) Patent Application Publication
(10) Pub. No.: US 2013/0275585 A1
(43) Pub. Date: Oct. 17, 2013

(54) SYSTEM AND METHOD FOR PERFORMANCE MEASUREMENT OF NETWORKED ENTERPRISE APPLICATIONS

(71) Applicants: Radhika Santhanakrishnan, Bangalore (IN); Reshma Sastry, Bangalore (IN); Sravanth Kumar Nagunuri, Dilsuknagar (IN); Pradeep Venkataraman, Bangalore (IN); Amit Kumar, Patna (IN); Venu Gopala Krishna Kishore Anumakonda, Kakinada (IN); Dakshinamurty Yanamandra, Bangalore (IN)

(72) Inventors: Radhika Santhanakrishnan, Bangalore (IN); Reshma Sastry, Bangalore (IN); Sravanth Kumar Nagunuri, Dilsuknagar (IN); Pradeep Venkataraman, Bangalore (IN); Amit Kumar, Patna (IN); Venu Gopala Krishna Kishore Anumakonda, Kakinada (IN); Dakshinamurty Yanamandra, Bangalore (IN)

(73) Assignee: INFOSYS LIMITED, Bangalore, Karnataka (IN)

(21) Appl. No.: 13/880,680

(22) PCT Filed: Oct. 22, 2010
(86) PCT No.: PCT/IN10/00689

§ 371 Date: Jul. 8, 2013

(51) Int. Cl. H04L 12/26

(52) U.S. Cl. CPC H04L 43/04
USPC 709/224

(57) ABSTRACT

A method for measuring performance of a networked application is provided. The method enables retrieving performance measurement data from an application database. The data relates to one or more transactions executed via the networked application. The method further enables reconstructing request and response messages using the retrieved data. The messages are reconstructed based on at least one of: web based and socket based calls related to one or more captured transactions. Further, the method enables determining one or more performance measurement metrics based on data obtained by communicating with one or more servers using the reconstructed messages.

### FIELD OF THE INVENTION

The present invention relates generally to software tools for measuring performance of network applications and more specifically to a system and method for measuring performance of networked enterprise applications.

### BACKGROUND OF THE INVENTION

Network communication systems such as the internet are increasingly being used by various enterprises for offering their services to users. For example, enterprises such as banks offer various services to users via the internet. Such enterprises employ networked applications to provide users with internal access to information stored in databases within the enterprise and for carrying out various transactions. The applications are typically invoked using protocols such as Hypertext Transfer Protocol (HTTP) for web-based applications and/or using protocols such as Transmission Control Protocol (TCP) for socket based applications. Optimal performance of the networked applications is vital for efficient functioning of various services offered by the enterprise. It is desirable that the networked applications respond efficiently to requests made by users and also operate properly when it is subjected to multiple requests simultaneously. In addition, it is desirable to determine the speed with which the networked applications respond to requests when load (i.e. number of users) on the application increases. Evaluating abovementioned performances to determine ability of the networked applications to respond under increasing load is referred to as load testing of the networked applications.

Several tools exist in the market to evaluate performance of various web-based software applications by simulating performances of users. Conventionally, enterprises employing networked applications use such tools as third-party tools to evaluate performances of the applications. However, use of such tools require knowledge about coding for performing various tasks such as scripting, testing and analyzing results to measure performance of applications. In addition, the existing tools use custom programming language to capture calls (i.e. request-response message) between client and one or more servers in a script. Knowledge of the custom programming language is needed by the user to run the script and replay the captured calls. Further, typically input data required by such third-party tools have to be generated manually which may lead to errors and is time consuming. Furthermore, use of such tools does not facilitate storing multiple performance results in a centralized repository within the tool which can be accessed in future for reference without incurring additional computational costs. In addition, some of the tools do not provide all the required performance metrics such as memory utilization, Central Processing Unit (CPU) utilization etc.

In light of the abovementioned disadvantages, there is a need for a system and method that provides a performance measuring tool which can be indigenously used for networked enterprise applications. The networked applications can be web or TCP socket based applications. There is a need for a system and method which can be used directly for measuring performance of networked applications without specific knowledge of coding used. Also, there is a need for a tool which can automatically fetch data required as input from an application database to evaluate performance of the application.

### BRIEF DESCRIPTION OF THE ACCOMPANYING DRAWINGS

The present invention is described by way of embodiments illustrated in the accompanying drawings wherein:

FIG. 1 is a block diagram of a system environment in which various embodiments of the present invention operate;

FIG. 2 is a detailed block diagram of a performance measurement tool, in accordance with an embodiment of the present invention;

FIGS. 3 and 4 illustrate flowcharts of a method for measuring performance of a networked application, in accordance with an embodiment of the present invention;

FIG. 5 is a process flow illustrating sequence of options displayed in a user interface for viewing performance measurement information, in accordance with an exemplary embodiment of the present invention.

### SUMMARY OF THE INVENTION

A method for measuring performance of a networked application is provided. In an embodiment of the present invention, the method comprises retrieving performance measurement data from an application database. The data relates to one or more transactions executed via the networked application. The method further comprises reconstructing request and response messages using the retrieved data. The messages are reconstructed based on at least one of: web based and socket based calls related to one or more captured transactions. Further, the method comprises determining one or more performance measurement metrics based on data obtained by communicating with one or more servers using the reconstructed messages.

In an embodiment of the present invention, retrieving performance measurement data from the application database comprises, firstly, identifying one or more predetermined keywords corresponding to one or more transactions. Secondly, the method comprises parameterizing one or more fields in a script based on the one or more predetermined keywords. Finally, the method comprises retrieving data for the one or more fields from the application database.

In an embodiment of the present invention, the performance measurement data comprises at least one of: number of virtual user simulation to be performed, account identification of the user, date of transaction, amount of transaction and any other user information.

A method for measuring performance of a networked application is provided. In an embodiment of the present invention, the method, firstly, comprises retrieving performance measurement data from an application database. The data relates to one or more transactions executed via the networked application. Secondly, the method comprises storing the retrieved performance measurement data in a centralized repository of a performance measurement tool. Secondly, the method comprises assigning one or more values to the retrieved data based on one or more predetermined rules. The method further comprises instantiating a shared object with the one or more values. The shared object defines web and socket based function and sending requests for executing one or more transactions to one or more servers using the shared object. Further, the method comprises storing request related data in the centralized repository as a first performance metric and receiving response from the one or more servers using the shared object. The method further comprises storing response related data in the centralized repository as a second performance measurement metric. The method comprises obtaining and storing resource utilization data in the centralized repository as third performance measurement metric. Finally, the method comprises computing an average value for each of the first, second and third performance measurement metrics and presenting performance measurement metrics to the user based on the average values in a predetermined format.

In an embodiment of the present invention, sending requests for executing one or more transactions to one or more servers using the shared object comprises generating at least one of: Hypertext Transport Protocol (HTTP), Hypertext Transport Protocol Secure (HTTP(S)), and Transmission Control Protocol (TCP) based request messages. The request related data stored as a first performance metric comprises at least one of number of users, number of transactions per user, number of transactions for total number of users, time taken per request and time taken for total number of requests. In another embodiment of the present invention, receiving response from the one or more servers using the shared object comprises receiving at least one of: web page response and data packet response corresponding to the requests made. In an embodiment of the present invention, the response related data stored as a second performance measurement metric comprises at least one of: response time per request, response time per set of requests and response time for total number of requests. In an embodiment of the present invention, the resource related data stored as third performance metric comprises at least one of: data related to memory and Central Processing Units (CPU) of one or more servers.

In an embodiment of the present invention, computing an average value for each of the first, second and third performance measurement metrics comprises computing an average value based on predetermined number of transactions executed during a predetermined time period.

A method for measuring performance of a networked application is provided. In an embodiment of the present invention, the method comprises, firstly, retrieving performance measurement data corresponding to one or more transactions from an application database. Secondly, the method comprises instantiating a shared object using the retrieved data. The shared object defines web and socket based function. The method comprises determining a set of performance measurement metric based on data obtained by communicating with one or more servers using the shared object. The data includes at least one of: request related data and response related data. Further, the method comprises repeating the above-mentioned steps to determine another set of performance measurement metric and comparing the determined sets of performance measurement metrics.

A system for measuring performance of a networked application is provided. In an embodiment of the present invention, the system comprises a load generator and a centralized repository. The load generator is configured to facilitate retrieving performance measurement data corresponding to one or more transactions from an application database. Further, the load generator comprises determining one or more performance measurement metrics based on data obtained by communicating with one or more servers using a shared object. The shared object defines at least in part web and socket based function and wherein the shared object is instantiated using the retrieved data. The centralized repository is configured to facilitate storing the one or more performance measurement metrics.

In an embodiment of the present invention, the system further comprises a user interface configured to facilitate obtaining the one or more performance measurement metrics from the centralized repository. The user interface is further configured to facilitate presenting the one or more performance measurement metrics to a user in a predetermined format.

In another embodiment of the present invention, the load generator uses an open source proxy to facilitate capturing calls between at least one of a client and the one or more servers and between the one or more servers.

In an embodiment of the present invention, the one or more servers comprise at least one of: a web server and an application server.

In an embodiment of the present invention, the centralized repository is configured to store the retrieved performance measurement data. In another embodiment of the present, invention, the centralized repository is configured to facilitate computing an average value for each of the performance measurement metrics based on predetermined number of transactions executed during a predetermined time period. In yet another embodiment of the present invention, the centralized repository is further configured to facilitate performing comparison of new and previous predetermined metrics obtained during execution of performance measurement of the networked application for a predetermined number of times.

A computer program product for measuring performance of a networked application is provided. In an embodiment of the present invention, the computer program product comprises a program instruction means for retrieving performance measurement data from an application database. The data relates to one or more transactions executed via the networked application. The computer program product further comprises a program instruction means for reconstructing request and response messages using the retrieved data. The messages are reconstructed based on at least one of: web based and socket based calls related to one or more captured transactions. Further, the computer program product comprises a program instruction means for determining one or more performance measurement metrics based on data obtained by communicating with one or more servers using the reconstructed messages.

A computer program product for measuring performance of a networked application is provided. In an embodiment of the present invention, the computer program product comprises a program instruction means for retrieving performance measurement data from an application database. The data relates to one or more transactions executed via the networked application. The computer program product further comprises a program instruction means for storing the retrieved performance measurement data in a centralized repository of a performance measurement tool. The computer program product comprises a program instruction means for assigning one or more values to the retrieved data based on one or more predetermined rules. The computer program product further comprises a program instruction means for instantiating a shared object with the one or more values. The shared object defines web and socket based function. Furthermore, the computer program product comprises a program instruction means for sending requests for executing one or more transactions to one or more servers using the shared object and a program instruction means for storing request related data in the centralized repository as a first performance metric. The computer program product further comprises a program instruction means for receiving response from the one or more servers using the shared object and a program instruction means for storing response related data in the centralized repository as a second performance measurement metric. The computer program product comprises a program instruction means for obtaining and storing resource utilization data in the centralized repository as third performance measurement metric. Further, the computer program product comprises program instruction means for computing an average value for each of the first, second and third performance measurement metrics and a program instruction means for presenting performance measurement metrics to the user based on the average values in a predetermined format.

A computer program product for measuring performance of a networked application is provided. In an embodiment of the present invention, the computer program product comprises a program instruction means for retrieving performance measurement data corresponding to one or more transactions from an application database. Further, the computer program product comprises a program instruction means for instantiating a shared object using the retrieved data. The shared object defines web and socket based function. Furthermore, the computer program product comprises a program instruction means for determining a set of performance measurement metric based on data obtained by communicating with one or more servers using the shared object. The data includes at least one of: request related data and response related data. The computer program product comprises a program instruction means for repeating the abovementioned to determine another set of performance measurement metric. Further, the computer program product comprises a program instruction means for comparing the determined sets of performance measurement metrics.

### DETAILED DESCRIPTION OF THE INVENTION

A system and method that provides a performance measurement tool for networked enterprise applications is disclosed. The invention facilitates capturing calls (request-response traffic) that are made between a user device and one or more applications, using HTTP or Hypertext Transfer Protocol Secure (HTTPS) or TCP or Java protocols, via the internet in a client-server architecture. The invention further facilitates generating load testing scripts using the captured calls. Further, the invention facilitates displaying one or more performance metrics related to operation of the applications on the user device for facilitating performance measurement of the applications. Further, the invention facilitates carrying out performance evaluation by scripting, testing and analyzing results without writing a code each time the tool is used. Furthermore, the invention facilitates storing performance measurement data in a centralized repository and retrieving the data therefrom for presenting to an end-user.

The following disclosure is provided in order to enable a person having ordinary skill in the art to practice the invention. Exemplary embodiments are provided only for illustrative purposes and various modifications will be readily apparent to persons skilled in the art. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

The present invention would now be discussed in context of embodiments as illustrated in the accompanying drawings.

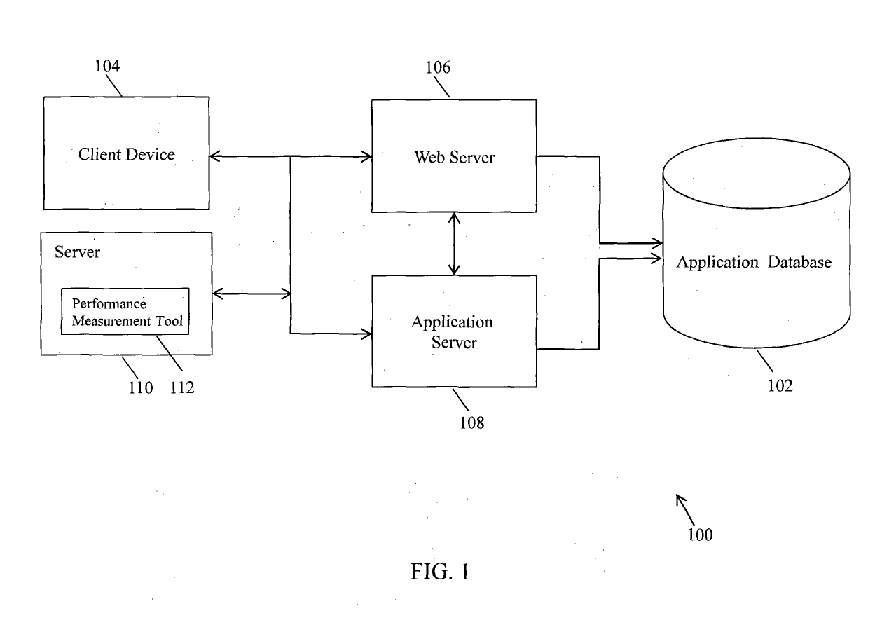

FIG. 1 is a block diagram of a system environment 100 in which various embodiments of the present invention operate. In various embodiments of the present invention, the system environment 100 is a client-server architecture having one or more networked applications. For example, networked application may include an online banking application facilitating a user to access his account details and carry out various transactions. The system environment 100 comprises one or more application databases 102 within an enterprise, a client device 104, a web server 106, and an application server 108. The system environment 100 further comprises a server 110 where a performance measuring tool 112 is installed.

Application database 102 is a repository used to store data related to users who are serviced by the enterprise via various applications. For example, in enterprises such as banks user related data may be stored in application databases 102 pertaining to various applications using predetermined codes or data structures or formats. The data may include demographic data, account and transaction data related to users and other data representing various facts related to the user. The data from application database 102 may comprise data related to customer relationship management such as campaign and service request data. Further, the data may comprise external data such as prospect data, and data corresponding to external customer databases like credit rating, enquiry data, etc. In an exemplary embodiment of the present invention, the application database 102 may include Relational Database Management Systems such as Oracle, SQL etc.

Client device 104 is an electronic communication device which may be used by one or more users to access various applications or services offered by an enterprise via a communication network. Examples of client device may include a, Personal Computer (PC), laptop, internet enabled mobile phone or any other computing device. The communication network may include Local Area Network (LAN), Virtual Private Network (VPN), Wide Area Network (WAN), internet, intranet, extranet and any other data communication network. In an embodiment of the present invention, the client device 104 is provided with front-end interface of an application database which facilitates one or more users to access data stored in the application database 102 and carry out various transactions. In another embodiment of the present invention, the front-end interface may include a Graphical User Interface (GUI) which facilitates one or more users to request and receive data stored in the application database 102 via an application server 108 using TCP protocol. In yet another embodiment of the present invention, the front-end interface may include a web-browser based Graphical User Interface (GUI) to facilitate one or more users to request and receive data stored in the application database 102 via a web server 106 using HTTP or HTTP (S) protocols.

Web server 106 comprises of one or more application software or computer programs for processing web service requests made by the client device 104. In an embodiment of the present invention, the web server 104 handles operation between users and the enterprise's back-end application. The web server receives HTTP or HTTP(S) requests from the client device 104, invokes operation of the application and processes the requests. The web server 104 further transmits response of the requests to the client device 104 using the HTTP or HTTP (S) over the communication network.

Application Server 108 comprises of one or more application software or computer programs for handling operations between users and the enterprise's back-end application. In an embodiment of the present invention, the application server 108 receives TCP based requests made by the client device 104. The application server 108 invokes operation of the application and processes the requests. The application server 108 further transmits response of the requests to the client device 104 using TCP protocol over the communication network. In another embodiment of the present invention, the application server 108 operates in combination with the web server 106 as a web application server.

In various embodiments of the present invention, server 110 comprises a performance measurement tool 112. The server 110 communicates with the networked application which comprises of the web server 106, the application server 108, and application database 102 over a communication network. The server 110 is used for emulating the client device 104 for measuring performance of the networked application. In an embodiment of the present invention, the application is Finacle® powered application.

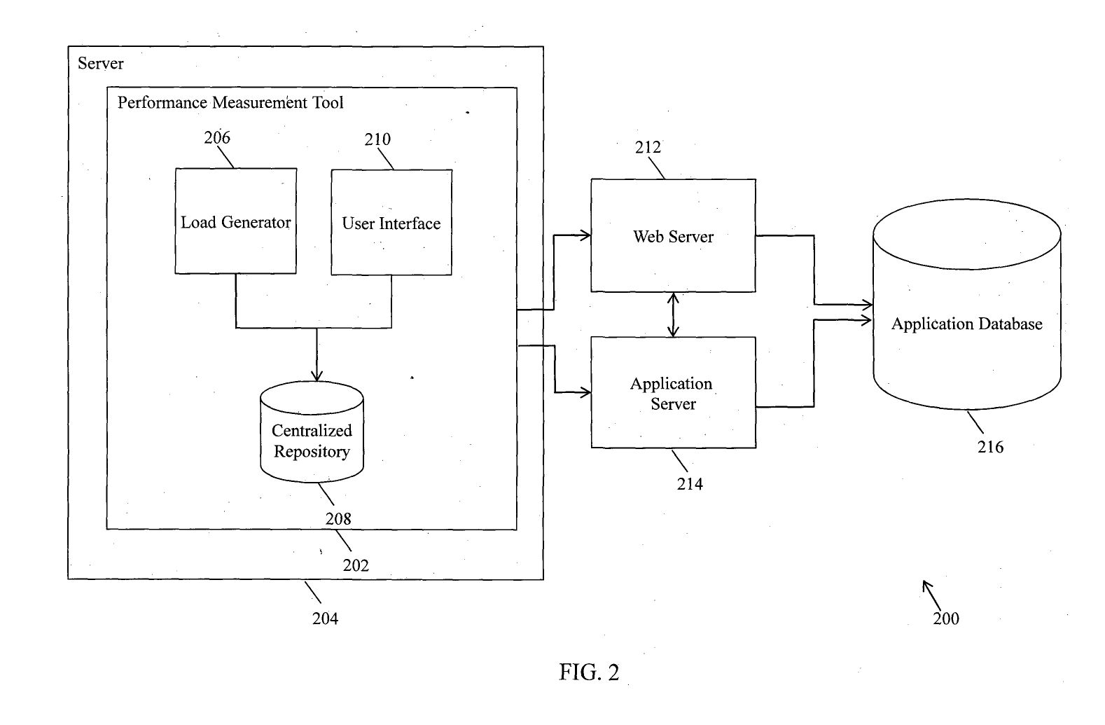

FIG. 2 is a detailed block diagram illustrating a performance measurement tool 202, in accordance with an embodiment of the present invention. The performance measurement tool 202 is installed on a server 204. The performance measurement tool 202 comprises a load generator 206, a centralized repository 208 and a user interface 210. The performance measurement tool 202 is used for measuring performance of one or more networked applications. The networked application comprises components such as a web server 212, an application server 214 and an application database 216. In an embodiment of the present invention, the performance measurement tool 202 is connected to one or more applications of an enterprise using HTTP, HTTP(S), JAVA and/or TCP Application Programming Interfaces (APIs).

Load generator 206 is a software module configured to generate load on various servers under performance test. The load generator 206 is configured with business logic of the performance measurement tool 202. In various embodiments of the present invention, business logic includes functional algorithms for handling information exchange between the networked application and the performance measurement tool 202. In an embodiment of the present invention, the load generator 206 facilitates generating a script for simulating a predetermined number of users and creating virtual users for evaluating performance of applications. The load generator 206 captures HTTP, HTTPS or TCP calls between a client device and one or more servers and generates the script by using the captured calls. The captured calls represent different transactions which may be carried out by a predetermined number of users. In an exemplary embodiment of the present invention, the load generator 206 captures HTTP or HTTP(s) calls between client (i.e. web browser) and web application using an open source proxy. The open source proxy facilitates to write the captured calls to the script. In another exemplary embodiment of the present invention, the load generator 206 captures TCP/IP calls between the web server 212 and application server 214 using open source proxy. The open source proxy facilitates to write the captured calls to the script. In yet another exemplary embodiment of the present invention, the script may be generated by using freeware tools which can act as network sniffers and capture HTTP, HTTP(S) and TCP calls.

In another embodiment of the present invention, the load generator 206 facilitates to provide an appropriate environment for running the script to simulate functionality of multiple users and evaluate performance measurement of the web server 212. The load generator 206 facilitates running scripts to generate or reconstruct HTTP or HTTP(S) or TCP or Java request and response messages using the captured calls. In an exemplary embodiment of the present invention, the HTTP, HTTP(S) request message is sent to web server 212 and a response message is received from the web server 212. The request-response message therefore aid in emulating user interactions between the web browser and web server 212. In another exemplary embodiment of the present invention, the TCP/IP request message is sent to the application server 214 and a response message is received from the application server 214. The request-response message therefore aid in emulating user interactions between the web server 212 and the application server 214. In another exemplary embodiment of the present invention, the response message can be parsed to extract data from the response message. The extracted data can be used in subsequent request messages.

In an embodiment of the present invention, the load generator 206 facilitates enhancing the script by analyzing and parameterizing request and response messages generated by the script. Parameterization may include inserting date, time and other user information such as login, password etc. in the request and response messages. In another embodiment of the present invention, the request messages are sent to a web server 212 or an application server 214 and response messages are received by the load generator 206. In an embodiment of the present invention, the load generator 206 sends the request messages in a controlled manner as per requirement. In an exemplary embodiment of the present invention, the load generator 206 may be configured to provide a lag time between two requests. In another exemplary embodiment of the present invention, the load generator 206 sends a set of messages to the web server 212 or application server 214. In yet another exemplary embodiment of the present invention, the load generator 206 repeatedly sends messages to the web server 212 or application server 214. In another embodiment of the present invention, the load generator 206 calculates response time for each request made and also calculates the total response time. In another embodiment of the present invention, the load generator 206 facilitates enhancing the script by adding ramp-up and think-times between iterations and within a particular transaction in the script. In an embodiment of the present invention, the script may be viewed and enhanced using a text editor.

In yet another embodiment of the present invention, the load generator 206 captures resource utilization information of the web server 212 and application server 214 such as CPU and memory utilization information. In another embodiment of the present invention, the load generator 206 retrieves input data from the application database 216 which is required to carry out performance measurement of the networked applications, creates performance measurement related input data files and stores performance related metrics data in the centralized repository 208. In yet another embodiment of the present invention, the load generator 206 creates performance measurement related input data files from files which are provided by end-users and stores the performance related metrics data in the centralized repository 208. The input, data may include, but is not limited to, account identification of the user, date of transaction, amount of transaction and any other user information.

In an embodiment of the present invention, result of simulation performed by the load generator 206 can be generated and obtained in a PDF report. In an exemplary embodiment of the present invention, the load generator 206 operates on UNIX or Windows platform. The script generation and execution programs are deployable and executable by UNIX or Windows operating system. In an embodiment of the present invention, the programs may be in ‘C’ and Java language. The result analysis and monitoring is performed by Java modules which are deployable and executable by UNIX or Windows operating system.

Centralized Repository 208 is a storage module of the performance measurement tool 202. In an embodiment of the present invention, the centralized repository 208 is configured to store data related to multiple transactions made by virtual users within the server 204. In an embodiment of the present invention, the load generator 206 stores input data required for performance measurement of the networked applications in the centralized repository 208. In another embodiment of the present invention, the load generator 206 stores performance metrics in the centralized repository 208. Performance metrics represent data which is obtained by carrying out performance measurement of the networked applications. Examples of performance metrics include, but are not limited to, number of users, number of transactions per user, response time per request and response time per set of requests. In an embodiment of the present invention, set of tables are created in the centralized repository 208 for storing the performance metrics. In another embodiment of the present invention; a mechanism is provided in the centralized repository 208 to aid in performing calculation of performance metrics. The centralized repository 208 is the key interface between the load generator 206 and the user interface 210.

User interface 210 gathers the performance metrics from the centralized repository 208 and outputs performance measurement results for viewing. In an embodiment of the present invention, the performance metrics is displayed in a user readable format. The user readable format may include Excel Sheet format and the final performance measurement result may be displayed in a Portable Document Format (PDF) report. The user interface 210 facilitates to view overall summary of performance measurement.

In another embodiment of the present invention, the user interface 210 facilitates to view each of the performance metric details. In yet another embodiment of the present invention, the performance metric data may be viewed in the form of graphs/charts. In another embodiment of the present invention, the user interface 210 facilitates to change the performance metric data as per requirement of the end-user. In, yet another embodiment of the present invention, based on desired duration of running the script by the end-user, the user interface 210 facilitates to view the performance metric data by filtering the performance metric data.

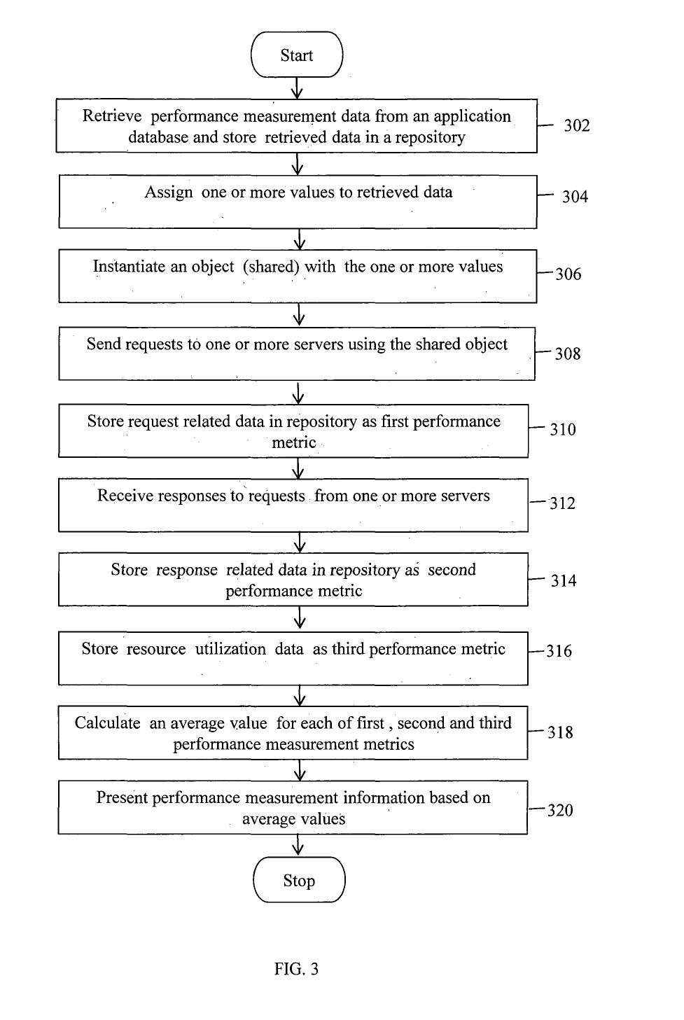

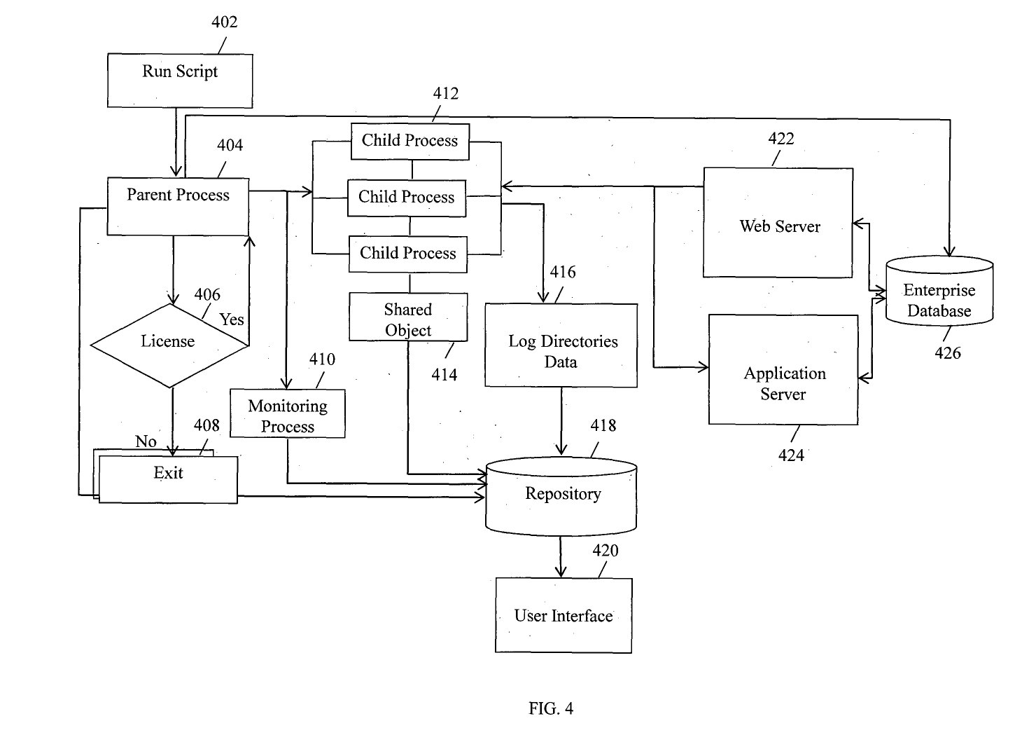

FIGS. 3 and 4 illustrate flowcharts of a method for measuring performance of a networked application, in accordance with an embodiment of the present invention.

At step 302, performance measurement data is retrieved from an application database and stored as retrieved data in a repository. In various embodiments of the present invention, a script is executed on a server by a performance measurement tool for emulating multiple users and, carrying out performance measurement of one or more servers in a networked application. In an embodiment of the present invention, the script is configured by the end-user with different transactions and stored in a script file to start performance measurement. The end-user is any user carrying out performance measurement or load testing of one or more servers. Based on the number of transactions configured in the script, predetermined number of processes is executed by running the script in an appropriate environment.

In an embodiment of the present invention, a parent process retrieves data which is required for measurement of performance of an application from an application database. In another embodiment of the present invention, the parent process retrieves data from performance related input data files provided by the end-user. In an exemplary embodiment of the present invention, data required to measure performance measurement may include number of virtual user simulation that has to be performed, account details of user accounts on which performance measurement is to be carried out, information related to user and account on which user has access, duration for carrying out performance measurement, transaction results which are to be monitored etc.

In an embodiment of the present invention, a configuration file may be maintained which comprises a set of keywords that may be used for parameterizing various fields in the script. The configuration file may be an XML (Extensible Markup Language) file. The keywords may be mapped to predetermined set of fields that correspond to different transaction types on which performance measurement is to be performed. One or more keywords from the set of keywords which are used for parameterizing various fields in the script may be enabled in the XML file. The parent process analyzes keywords which are enabled in the XML file. The parent process retrieves data from the application database which is associated with the fields in the script that correspond to the keywords. The parent process uses appropriate database access details to retrieve data from the database using database queries. In an embodiment of the present invention, the retrieved data is stored in the repository in the form of binary format files.

At step 304, retrieved data is assigned one or more values based on one or more predetermined rules. In an embodiment of the present invention, the one or more values include a global value which can be accessed by one or more transactions. The one or more values also include local values which are specific to one or more transactions. In an embodiment of the present invention, the predetermined rules may include, but is not limited to, selecting data randomly from retrieved data, selecting data from retrieved data in a sequence or using a single value of data throught performance execution. The assigned values are populated in a linked list in the repository.

For example, transaction X and transaction Y may require same retrieved data for measuring performance of both the transactions. Using the global value, both the transactions X and Y can access the retrieved data and using the local values, transactions X and Y can be executed. In an exemplary embodiment of the present invention, the retrieved data may include account number, transaction X may include balance enquiry using the account number and transaction Y may include cash or demand draft deposit using the same account number.

At step 306, a shared object defining web and socket based function is instantiated, with the one or more values. In an embodiment of the present invention, the parent process creates one or more child processes to read the local values from the linked list. In an embodiment of the present invention, the child process instantiates a shared object. The shared object defines HTTP, HTTP (S) and TCP based functions. HTTP, HTTP (S) and TCP request or response messages are reconstructed using the shared object. In an embodiment of the present invention, the request messages may be parameterized. Parameterizing the request messages may include adding parameterizing tags such as inserting date, time and other user information such as user account number, user branch number, user cheque or instrument number, user operating zone identification etc. in the request messages.

At step 308, requests are sent to one or more servers to execute one or more transactions using the shared object. In an embodiment of the present invention, functions within the shared object are used to send requests to the web server to execute a transaction. In an exemplary embodiment of the present invention, the script may be parsed and parameterizing tags may be replaced with actual data values. The HTTP requests are sent to the web server using an external library API i.e. LibCurl. In another embodiment of the present invention, functions within the shared object are used to send requests to the application server to execute a transaction. In an exemplary embodiment of the present invention, TCP requests are sent to the application server using socket connections. In an embodiment of the present invention, the shared object calculates time taken for each request made to the web server or to the application server.

At step 310, request related data is stored in the centralized repository as a first performance metric. In an embodiment of the present invention, the request related data may include number of users, number of transactions per user, number of transactions for all the users, time taken per request and time taken for all the requests. The request related data is stored in the centralized repository in tables as first performance metric.

At step 312, response from the one or more servers is received. In an embodiment of the present invention, the web server or the application server sends responses to requests which are received by the shared object. The shared object informs one or more child processes of the responses which is then captured by the one or more child processes as message patterns. In another embodiment of the present invention, the shared object calculates response time values of web page responses received from the web server and data packet responses received from the application server and informs the same to the child processes. The child processes writes the response time values to log files in a log directory. In an embodiment of the present invention, each child process captures reply status of one or more transaction request made and writes other details such as start time and end time of each transaction to log files in a log directory. In an embodiment of the present invention, the above-mentioned values are uploaded in the centralized repository.

At step 314, response related data is stored in the repository as a second performance measurement metric. In an embodiment of the present invention, the response time values are stored in the centralized repository in tables as second performance metric. The response time values may include response time per transaction request, response time per set of transaction requests and response time for total number of requests made.

At step 316, resource utilization data is obtained and stored in the centralized repository as third performance measurement metric. In an embodiment of the present invention, the parent process creates a monitoring process for monitoring resource utilization of the one or more servers when the performance measurement is being carried out. Resource utilization data includes data related to memory and Central Processing Unit (CPU) utilization of the one or more servers. The data is stored in a table in the centralized repository.

In various embodiments of the present invention, performance metrics related to various transactions of different projects are stored in the centralized repository. The different projects are segregated in the centralized repository using different project names or codes. For each project one or more performance measurement may be carried out and the performance measurement metrics may be stored in the centralized repository. The performance measurement metric for each performance measurement may be identified with performance identification (ID).

At step 318, an average value is computed for each of the first, second and third performance measurement metrics. In an embodiment of the present invention, the average values for each of the three metrics are computed by using stored procedures. The average values may be stored in a table in the centralized repository.

In various embodiments of the present invention, a first set of performance measurement metrics is obtained using steps 302 to 318 for an application. The first set of performance measurement metrics may be referred as base set. The base set of performance measurement metrics facilitates the end-user to identify performance bottlenecks that exist in the application and rectify the identified bottlenecks. After rectification measures are applied, a second set of performance measurement metrics may be obtained by repeating steps 302 to 318. The second set of performance measurement metrics is used to identify whether rectification measures are optimal and also used to identify further performance bottlenecks in the application.

The base set and the second performance measurement metrics can be compared using stored procedures. The comparison facilitates the end-user to identify an overall improvement in the performance of the application. If overall improvement is determined, the second set of performance measurement metrics may be considered as base set. After further rectification measures are applied, a second set of performance measurement metrics may be obtained by repeating steps 302 to 318 as described in paragraph 0057. This process may be repeated until predetermined objectives of performance measurement are met.

For example, based on the comparison result, it may be identified that there is increase in application-side CPU utilization, increase in application-side memory utilization, decrease in application database-side CPU utilization, and decrease in application database-side memory utilization. Based on the above-mentioned, it may be determined that application-side caching is required to be included.

At step 320, performance measurement information is presented to the user based on the average values. In an embodiment of the present invention, a user interface of the performance measurement tool reads the average values from the centralized repository and renders the performance measurement information to the end-user in a predetermined format. For example, an average value of the second performance metric may include an average of response times of total number of transactions that have been executed during a predetermined time period.

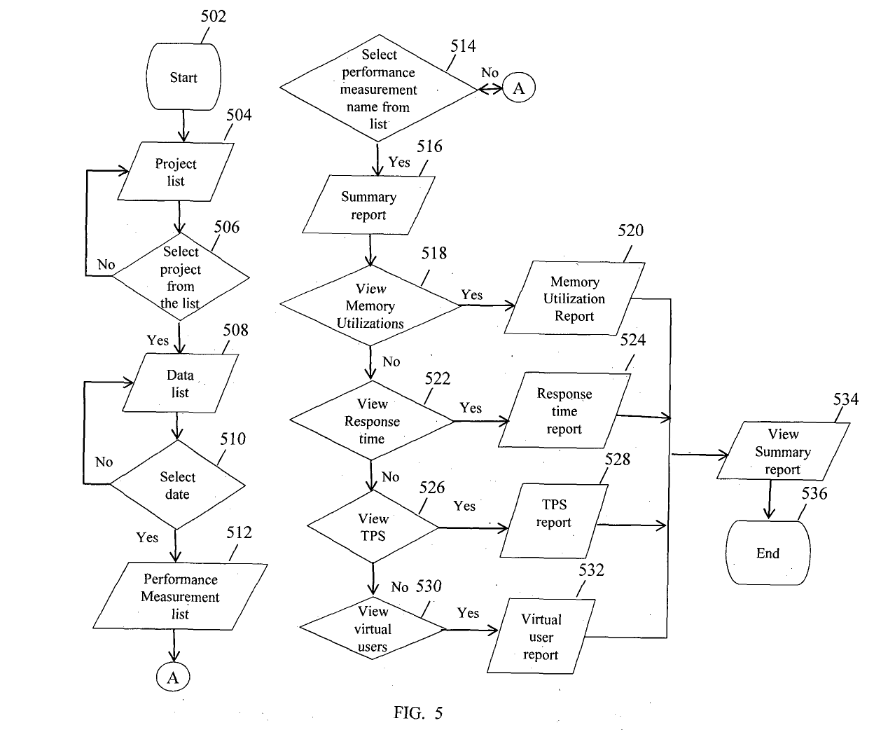

FIG. 5 is a process flow illustrating sequence of options displayed in a user interface for viewing performance measurement information, in accordance with an exemplary embodiment of the present invention.

The user interface provides a login page which presents an option to the end user to login as a local user or as an admin user. In case the end user logs in as a local user the user can select a project for which user wishes to view one or more performance measurement metrics. The end-user can choose a date range from a calendar provided on the user interface and can select the exact date when the performance measurement was carried out. In case of more than one performance measurement carried out on the selected date, the user can select desired performance measurement identification from a list of performance measurement identifications. Upon selection, the user is presented with a summary report of the selected performance measurement identification which includes the performance measurement metrics. The summary report may also include graphical representation of the performance measurement metrics. The end-user may obtain the performance metric data in an excel format and a PDF format. The performance measurement metrics represent, for example, the average response time, number of transactions per second, and utilization of CPU and memory of one or more servers. The user interface also provides the end-user an option to view two metric graphs of same performance measurement in a single graph. Further, the user interface provides an option to reduce a graph to smaller portion if the end user intends to concentrate on a particular time period in the performance measurement. Furthermore, the end-user can also change points displayed in the graph by adjusting coarseness of graph values.

In another exemplary embodiment of the present invention, in case the end-user opts to login as admin user, the user interface provides the end-user an option to select the operation and type. Operation can be ‘Add’, ‘Modify’, ‘Delete’ or ‘View’. Type can be ‘User’, ‘Server’ or ‘Project’. For example, the end-user can select ‘Add Server’, ‘Add Project’ or ‘Add User’. Further, the end-user can select ‘Modify Server’, ‘Modify User’ or ‘Modify Project’. Furthermore, the end-user can ‘View Server’, ‘View Project’, ‘View Performance Measurement’ or ‘Delete Server’, ‘Delete Project’, ‘Delete Performance Measurement’ or ‘Delete User’. If end-user selects ‘Add User’ then the user interface provides option to fill details such as username, password and role of the user. If the end-user selects ‘Add Server’, then, the user interface provides option to fill details such as Internet Protocol (IP) address, server type, model, username, clock speed, Operating System (OS) information, host name, number of CPU, memory, threads per CPU, password, etc. If the end-user selects ‘Add Project’, then, the user interface provides the option to write project code, application server's IP, database server's IP, web server's IP, load generator sever, HTTP server and port number. The user can add details of more than one server for each type. If the end user selects ‘Modify User’, then the user interface provides option to fill User Identification (Id) of user whose details he wants to change. If the user id already exists then the user interface shows, his previous role and provides option to select a new role.

If the end-user selects ‘Modify Server’, then, the user interface provides IP address and all the details of that server will be presented which the user can modify. If the end user selects ‘Modify Project’, then user interface provides an option to enter the project name whose details he wishes to change. If the project code exists, then, the user interface renders all the details of that project which he can modify. Similarly, when the end user selects options like ‘View Server’ or ‘View Performance Measurement’ or ‘View Project’, then the user interface shows all the details of the selected options. If the end user selects ‘Delete Server’ and enters the machine IP of the Server, the corresponding server will get deleted. If the end user selects ‘Delete Performance Measurement’ and enters the performance measurement name, then, performance measurement metrics can be deleted from the centralized repository. If user selects ‘Delete Project’ and enters the ‘Project Name’, then, that project will be deleted from the centralized repository. If the end user selects ‘Delete User’ and enters the user name and role, then that user can be deleted from the centralized repository.

The present invention may be implemented in numerous ways including as a apparatus, method, or a computer program product such as a computer readable storage medium or a computer network wherein programming instructions are communicated from a remote location.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims.

We claim:

1. A method for measuring performance of a networked application, the method comprising:
retrieving performance measurement data from an application database, wherein the data relates to one or more transactions executed via the networked application;
reconstructing request and response messages using the retrieved data, wherein the messages are reconstructed based on at least one of: web based and socket based calls related to one or more captured transactions; and
determining one or more performance measurement metrics based on data obtained by communicating with one or more servers using the reconstructed messages.

2. The method of claim 1, wherein retrieving performance measurement data from the application database comprises:
identifying one or more predetermined keywords corresponding to one or more transactions;
parameterizing one or more fields in a script based on the one or more predetermined keywords; and
retrieving data for the one or more fields from the application database.

3. The method of claim 1, wherein the performance measurement data comprises at least one of: number of virtual user simulation to be performed, account identification of the user, date of transaction, amount of transaction and any other user information.

4. A method for measuring performance of a networked application, the method comprising:
retrieving performance measurement data from an application database, wherein the data relates to one or more transactions executed via the networked application;
storing the retrieved performance measurement data in a centralized repository of a performance measurement tool;
assigning one or more values to the retrieved data based on one or more predetermined rules;
instantiating a shared object with the one or more values, wherein the shared object defines web and socket based function;
sending requests for executing one or more transactions to one or more servers using the shared object;
storing request related data in the centralized repository as a first performance metric;
receiving response from the one or more servers using the shared object;
storing response related data in the centralized repository as a second performance measurement metric;
obtaining and storing resource utilization data in the centralized repository as third performance measurement metric;
computing an average value for each of the first, second and third performance measurement metrics; and
presenting performance measurement metrics to the user based on the average values in a predetermined format.

5. The method of claim 4, wherein sending requests for executing one or more transactions to one or more servers using the shared object comprises generating at least one of: Hypertext Transport Protocol (HTTP), Hypertext Transport Protocol Secure (HTTP(S)), and Transmission Control Protocol (TCP) based request messages.

6. The method of claim 4, wherein the request related data stored as a first performance metric comprises at least one of: number of users, number of transactions per user, number of transactions for total number of users, time taken per request and time taken for total number of requests.

7. The method of claim 4, wherein receiving response from the one or more servers using the shared object comprises receiving at least one of: web page response and data packet response corresponding to the requests made.

8. The method of claim 4, wherein response related data stored as a second performance measurement metric comprises at least one of: response time per request, response time per set of requests and response time for total number of requests.

9. The method of claim 4, wherein the resource related data stored as third performance metric comprises at least one of: data related to memory and Central Processing Units (CPU) of one or more servers.

10. The method of claim 4, wherein computing an average value for each of the first, second and third performance measurement metrics comprises computing an average value based on predetermined number of transactions executed during a predetermined time period.

11. A method for measuring performance of a networked application comprising:
a. retrieving performance measurement data corresponding to one or more transactions from an application database;
b. instantiating a shared object using the retrieved data, wherein the shared object defines web and socket based function;
c. determining a set of performance measurement metric based on data obtained by communicating with one or more servers using the shared object, wherein the data includes at least one of: request related data and response related data; and
d. repeating steps a. to c. to determine another set of performance measurement metric; and
e. comparing the determined sets of performance measurement metrics.

12. A system for measuring performance of a networked application, the system comprising:
a load generator configured to facilitate:
retrieving performance measurement data corresponding to one or more transactions from an application database;
determining one or more performance measurement metrics based on data obtained by communicating with one or more servers using a shared object, wherein the shared object defines at least in part web and socket based function and wherein the shared object is instantiated using the retrieved data; and
a centralized repository configured to facilitate storing the one or more performance measurement metrics.

13. The system of claim 12 further comprising a user interface configured to facilitate:
obtaining the one or more performance measurement metrics from the centralized repository; and
presenting the one or more performance measurement metrics to a user in a predetermined format.

14. The system of claim 12, wherein the load generator uses an open source proxy to facilitate capturing calls between at least one of: a client and the one or more servers and between the one or more servers.

15. The system of claim 12, wherein the one or more servers comprises at least one of: a web server and an application server.

16. The system of claim 12, wherein the centralized repository is configured to store the retrieved performance measurement data.

17. The system of claim 12, wherein the centralized repository is configured to facilitate computing an average value for each of the performance measurement metrics based on predetermined number of transactions executed during a predetermined time period.

18. The system of claim 12, wherein the centralized repository is further configured to facilitate performing comparison of new and previous predetermined metrics obtained during execution of performance measurement of the networked application for a predetermined number of times.

19. A computer program product for measuring performance of a networked application, the computer program product comprising:
program instruction means for retrieving performance measurement data from an application database, wherein the data relates to one or more transactions executed via the networked application;
program instruction means for reconstructing request and response messages using the retrieved data, wherein the messages are reconstructed based on at least one of: web based and socket based calls related to one or more captured transactions; and
program instruction means for determining one or more performance measurement metrics based on data obtained by communicating with one or more servers using the reconstructed messages.

20. A computer program product for measuring performance of a networked application, the method comprising:
program instruction means for retrieving performance measurement data from an application database, wherein the data relates to one or more transactions executed via the networked application;
program instruction means for storing the retrieved performance measurement data in a centralized repository of a performance measurement tool;
program instruction means for assigning one or more values to the retrieved data based on one or more predetermined rules;
program instruction means for instantiating a shared object with the one or more values, wherein the shared object defines web and socket based function;
program instruction means for sending requests for executing one or more transactions to one or more servers using the shared object;
program instruction means for storing request related data in the centralized repository as a first performance metric;
program instruction means for receiving response from the one or more servers using the shared object;
program instruction means for storing response related data in the centralized repository as a second performance measurement metric;
program instruction means for obtaining and storing resource utilization data in the centralized repository as third performance measurement metric;
program instruction means for computing an average value for each of the first, second and third performance measurement metrics; and
program instruction means for presenting performance measurement metrics to the user based on the average values in a predetermined format.

21. A computer program product for measuring performance of a networked application comprising:
a. program instruction means for retrieving performance measurement data corresponding to one or more transactions from an application database;
b. program instruction means for instantiating a shared object using the retrieved data, wherein the shared object defines web and socket based function;
c. program instruction means for determining a set of performance measurement metric based on data obtained by communicating with one or more servers using the shared object, wherein the data includes at least one of: request related data and response related data; and
d. program instruction means for repeating steps a. to c. to determine another set of performance measurement metric; and
e. program instruction means for comparing the determined sets of performance measurement metrics.
